(19) United States
(12) Patent Application Publication
(10) Pub. No.: US 2013/0119031 A1
(43) Pub. Date: May 16, 2013

(54) LASER LIFT-OFF METHOD AND LASER LIFT-OFF APPARATUS

(71) Applicants: Ryozo Matsuda, Tokyo (JP); Keiji Narumi, Shizuoka (JP); Kazuya Tanaka, Kanagawa (JP); Kazuki Shinoyama, Kanagawa (JP); Takashi Matsumoto, Shizuoka (JP)

(72) Inventors: Ryozo Matsuda, Tokyo (JP); Keiji Narumi, Shizuoka (JP); Kazuya Tanaka, Kanagawa (JP); Kazuki Shinoyama, Kanagawa (JP); Takashi Matsumoto, Shizuoka (JP)

(73) Assignee: USHIO INC., Tokyo (JP)

(21) Appl. No.: 13/811,094

(22) PCT Filed: Sep. 28, 2010
(86) PCT No.: PCT/JP2010/066792

§ 371 Date: Jan. 18, 2013

(30) Foreign Application Priority Data
Jul. 20, 2010 (JP) 2010-163273

(51) Int. Cl. B23K 26/00

(52) U.S. Cl. CPC B23K 26/00
USPC 219/121.85

(57) ABSTRACT

A substrate is separated from a material layer formed on the substrate without generating cracks in the material layer formed on the substrate. In order to separate the material layer from the substrate at a boundary between the substrate (1) and the material layer (2), pulsed laser light (L) is applied, through the substrate (1), to a workpiece (3) having the material layer (2) formed on the substrate (1), while from moment to moment changing an irradiation region with respect to the workpiece (3), in such a manner that the adjacent irradiation regions overlap each other on the workpiece (3). The region where the pulsed laser light (L) is applied to the work (3) is set to satisfy the relationship of S/0.125, where S (mm²) is the area of the irradiation region, and L (mm) is the circumferential length of the irradiation region. Consequently, the material layer can be reliably separated from the substrate without generating cracks in the material layer formed on the substrate.

### TECHNICAL FIELD

The present invention relates to a laser lift-off method and a laser lift-off apparatus, in a manufacturing process of a semiconductor light emitting element, which is formed of a compound semiconductor, for separating a material layer from a base plate by irradiating the material layer formed on the base plate with laser light, thereby breaking down the material layer (hereinafter referred to as a laser lift-off). In particular, the present invention relates to a laser lift-off method and a laser lift-off apparatus, in which a workpiece is irradiated with pulsed laser light having a small irradiation area through a base plate, and a crystalline layer is separated from the base plate on the boundary face between the base plate and the crystalline layer, while changing from moment to moment a region of the workpiece irradiated with the pulsed laser light.

### BACKGROUND ART

In a manufacturing process of a semiconductor light emitting element, which is formed of GaN (gallium nitride) series compound semiconductor, there is known a technique of a laser lift-off for separating a crystalline layer of a GaN series compound, which is formed on a sapphire base plate, therefrom by irradiation with laser light from a back side of the sapphire base plate. Hereinafter, a laser lift-off refers to separation of such a crystalline layer (hereinafter referred to as a material layer), which is formed on a base plate, therefrom by irradiating the material layer with laser light. For example, Patent Literature 1 discloses a GaN layer is formed on a sapphire base plate, and GaN, which forms the GaN layer, is broken down by irradiating it with laser light from a back side of the sapphire base plate, so that the GaN layer is separated from the sapphire base plate. A piece, in which the material layer is formed on the base plate, is referred to as a workpiece.

### CITATION LIST

### Patent Literature

Patent Literature 1: Japanese Patent Application Publication No. 2001-501778

### DISCLOSURE OF INVENTION

### Technical Problem

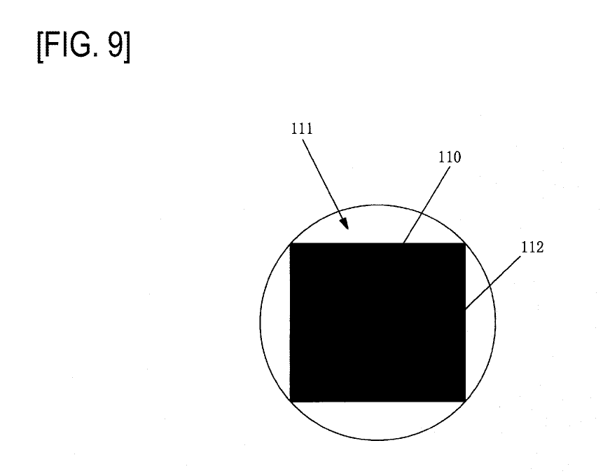

In order to separate the GaN series compound material layer formed on the sapphire base plate by irradiating the GaN series compound material layer with laser light from the back side of the sapphire base plate, it becomes important to irradiate it with the laser light, which has irradiation energy more than the breakdown threshold required for breaking down the GaN series compound into Ga and N₂. Here, since N₂ gas is produced when it is irradiated with the laser light so that the GaN may be broken down, a shearing stress is applied to the GaN layer, and cracks may occur in the boundary part of the region which is irradiated with the laser light. For example, there is a problem that when a region 110, which is irradiated with one shot of laser light, is a square as shown in FIG. 9, cracks may occur in the boundary 112 of the laser light irradiation region of the GaN layer 111. Especially, when an element is formed by using a GaN series compound material layer whose thickness is several g m or less, the GaN series compound material layer may not have enough strength to bear the shearing stress due to generation of the N₂ gas, and cracks may occur easily. Furthermore, not only the cracks are generated in the GaN series compound material layer but they are also passed on to a light emitting layer etc. which is formed on the GaN series compound material layer, so that the element itself may be destroyed, whereby it has been a problem when a minute size element is formed. According to the present invention, the above-mentioned problem is solved, and it is an object of the present invention to offer a laser lift-off method and apparatus, capable of separating a material layer from a base plate, without cracking the material layer formed on the base plate.

### Solution to Problem

The present inventors carefully studied and found out that while an edge part of the irradiation region is damaged when GaN is broken down by irradiation with pulsed laser light, the size of the damage due to this breakdown depends on the irradiated area of the laser light to a great extent, but, although it was thought that a larger force was applied to the boundary (edge part) of the irradiation region of the pulsed laser light as the irradiation area S was larger, when the length L (boundary length of the irradiation region) of the edge part becomes large, a force, which is applied to per unit length of the edge part, becomes small so that even if the irradiation area is the same, the damage thereto becomes small. That is, it is thought that the damage can be made small by making small a value of [irradiation area S]/[boundary length L], and specifically it is found out that a laser lift-off treatment can be performed without causing any damage by setting the above-mentioned value S/L to 0.125 or less. In view of the above, the above-mentioned problem is solved by the present invention as set forth below. (1) In a laser lift-off method, in which a workpiece, where a crystalline layer is formed on a base plate, is irradiated with pulsed laser light through the base plate, and the crystalline layer is separated from the base plate on the boundary face between the base plate and the crystalline layer, while changing from moment to moment the region of the workpiece irradiated with the pulsed laser light, wherein the region of the workpiece irradiated with the pulsed laser light, satisfies a relation of S/L≦0.125 when the area of this region of the workpiece irradiated with the pulsed laser light is represented as S (mm²) and the boundary length of the irradiation region is represented as L (mm). (2) In the above-mentioned (1), the region of the workpiece irradiated with the pulsed laser light is quadrangular. (3) A laser lift-off apparatus, in which a workpiece, where a crystalline layer is formed on a base plate, is irradiated with pulsed laser light through the base plate, and the crystalline layer is separated from the base plate on the boundary face between the base plate and the crystalline layer, while changing from moment to moment a region of the workpiece irradiated with the pulsed laser light, comprises: a laser source for generating the pulsed laser light of a wavelength band, which passes through the base plate and is required for breakdown of the crystalline layer; a conveyance mechanism, which conveys the workpiece; and a laser optical system, which forms the pulsed laser light emitted from the laser source, so as to satisfy a relation of S/L≦0.125, when the area of the region of the workpiece irradiated with the pulsed laser light is represented as S (mm²) and the boundary length of the irradiation region is represented as L (mm). (4) In the above-mentioned (3), the laser optical system forms the region of the workpiece irradiated with the pulsed laser light so as to be quadrangular.

### Advantageous Effects of Invention

According to the laser lift-off method of the present invention, effects set forth below can be expected. When the region of the workpiece to be irradiated with the pulsed laser light, satisfies the relation of S/L≦0.125, wherein the area of this region of the workpiece irradiated with the pulsed laser light is represented as S (mm²) and the boundary length of the irradiation region is represented as L (mm), it is possible to reduce damage applied to an edge portion of the irradiation region of the pulse laser light, so that it is possible to prevent generation of cracks in the material layer. When the irradiation region is quadrangular, the entire face of the workpiece is irradiated with laser light while superimposing the edges of the irradiation region by making the irradiation region quadrangular.

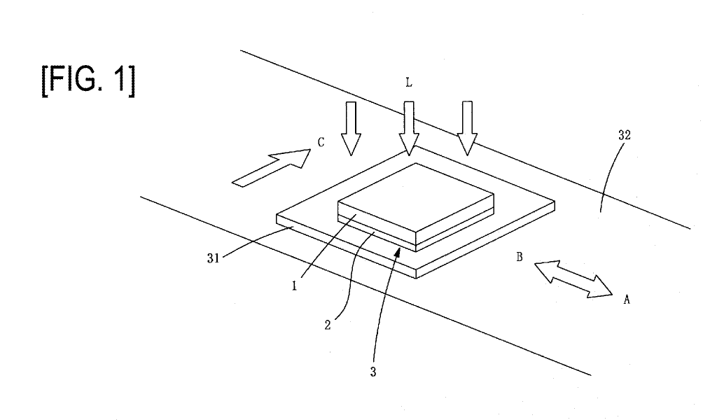

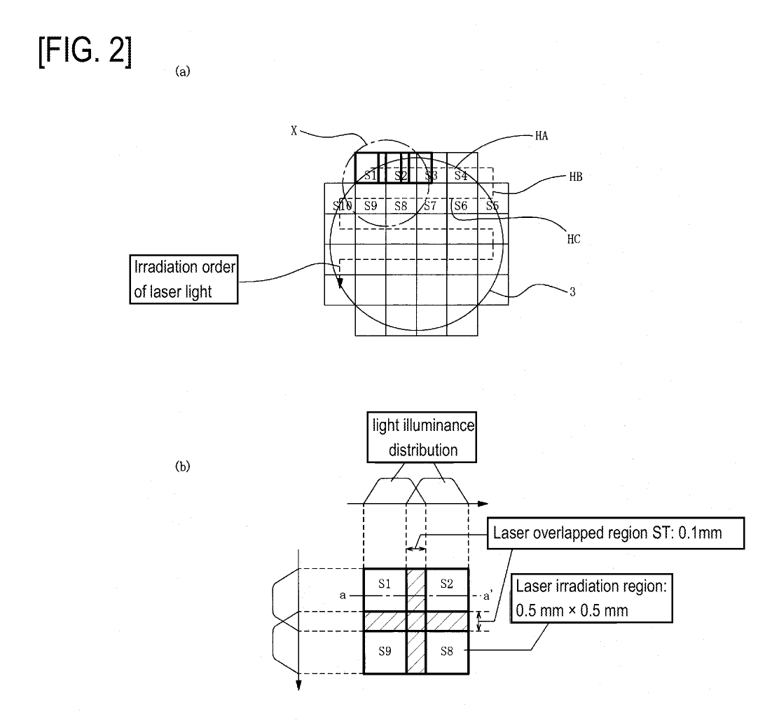

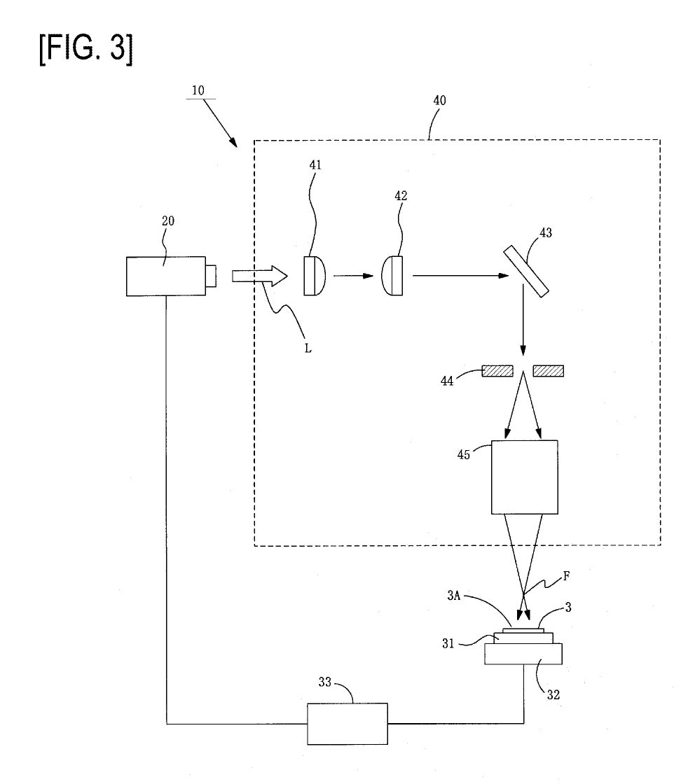

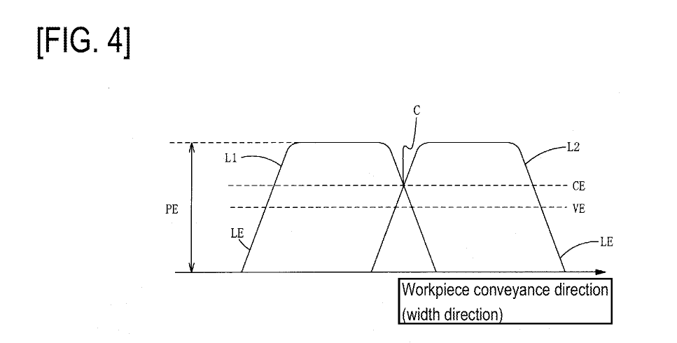

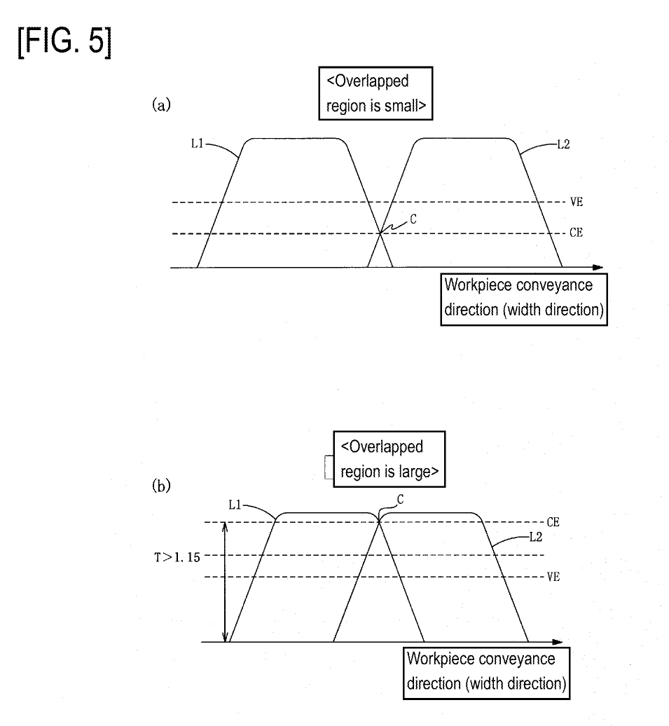

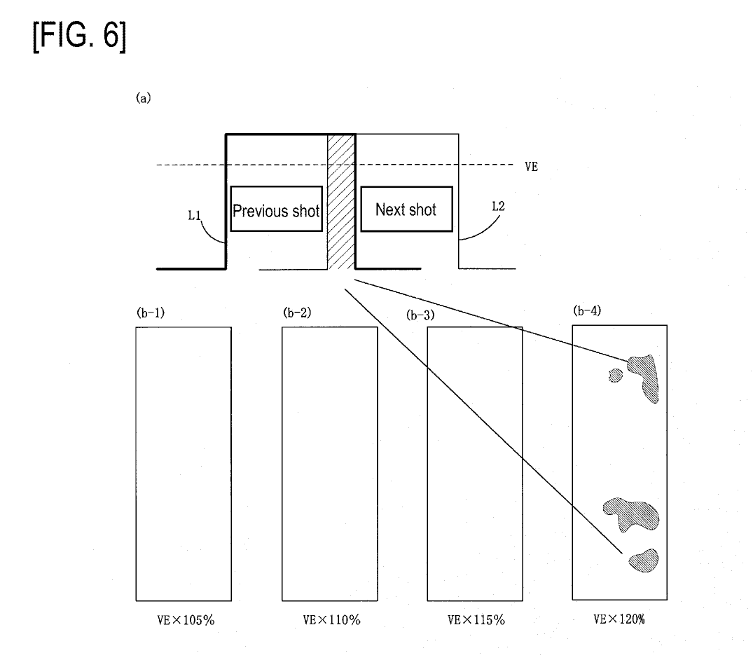

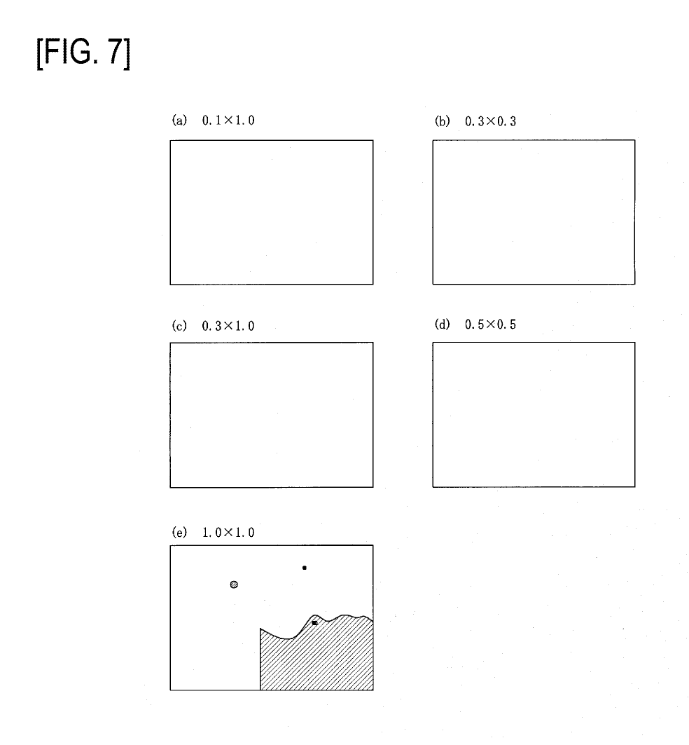

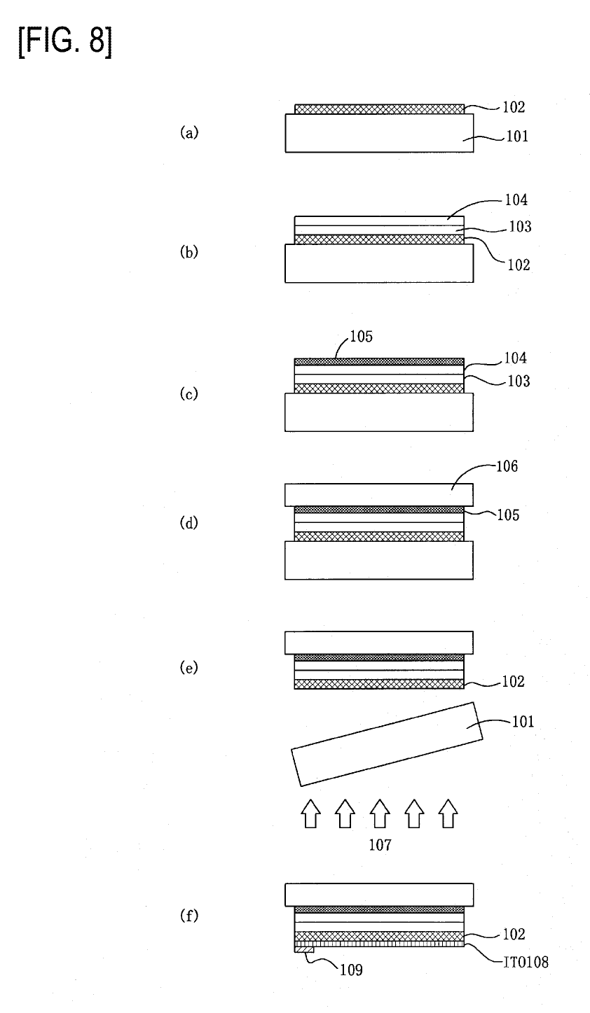

### BRIEF DESCRIPTION OF DRAWINGS

[FIG. 1] It is a conceptional diagram for explaining a laser lift-off treatment according to an embodiment of the present invention.

[FIG. 2] It is a diagram showing a state where a workpiece is irradiated with laser light.

[FIG. 3] It is a conceptional diagram of a laser lift-off apparatus according to an embodiment of the present invention.

[FIG. 4] It is a diagram showing light intensity distribution of laser light which is superimposed on regions S1 and S2 of a workpiece to be irradiated, which are adjacent to each other, in an embodiment of the present invention.

[FIG. 5] It is a diagram showing a comparative example for comparison with light intensity distribution of laser light according to the present embodiment.

[FIG. 6] It is a diagram showing a result of an experiment in which influences of laser light superposition degree on a material layer after separation were examined.

[FIG. 7] It is a schematic diagram showing a surface condition of a material layer after separation in case where the area of an irradiation region and the shape thereof are changed and it is irradiated with laser light.

[FIG. 8] It is a diagram for explaining a method for manufacturing a semiconductor light emitting element to which a laser lift-off treatment can be applied.

[FIG. 9] It is a diagram showing case where an irradiation region at one shot of laser light is a square.

### DESCRIPTION OF EMBODIMENT

FIG. 1 is a conceptional diagram for explaining a laser lift-off treatment according to an embodiment of the present invention. As shown in the figure, in this embodiment, the laser lift-off treatment is performed as set forth below. A workpiece 3 where a material layer 2 is formed on a base plate 1 which transmits laser light, is placed on a workpiece stage 31. The workpiece stage 31, on which the workpiece 3 is put, is placed in a conveyance mechanism 32 such as a conveyor, and is conveyed at a predetermined speed by the conveyance mechanism 32. The workpiece 3 is irradiated with pulsed laser light L through the base plate 1 from a pulsed laser source, which is not illustrated in figure, while it is conveyed together with the workpiece stage 31 in a direction of arrows A and B in the figure. As to the workpiece 3, the material layer 2 made of a GaN (gallium nitride) series compound is formed on a surface of the base plate 1 made of sapphire. The base plate 1 may be any as long as the material layer made of the GaN series compound can be formed well thereon, and it transmits laser light of a wavelength required for breaking down the GaN series compound material layer. Such a GaN series compound is used for the material layer 2, so that high output blue light may be efficiently outputted with low input energy.

The laser light should be suitably selected according to material which forms the base plate 1 and the material layer to be separated from the base plate 1. When the material layer 2 of the GaN series compound is separated from the base plate 1 made of sapphire, a KrF (krypton-fluorine) excimer laser, which emits a wavelength of, for example, 248 nm, can be used. Light energy (5 eV) of the laser wavelength of 248 nm is between the band gap (3.4 eV) of GaN and the band gap (9.9 eV) of sapphire. Therefore, laser light with the wavelength of 248 nm is desirable, in order to separate the material layer of the GaN series compound from the base plate of sapphire.

Next, description of a laser lift-off treatment according to an embodiment of the present invention will be given below referring to FIGS. 1 and 2. FIG. 2 is a diagram showing a state where the workpiece 3 is irradiated with laser light L. FIG. 2(a) shows an irradiation method of laser light to the workpiece 3, FIG. 2(b) shows an enlarged view of an X portion of FIG. 2(a), in which FIG. 2(b) shows an example of a cross section of light intensity distribution of the laser light irradiated on each irradiation region of the workpiece 3. In addition, solid lines on the workpiece 3 shown in FIG. 2 virtually shows regions to be irradiated with the laser light. The workpiece 3 is repeatedly conveyed in directions of arrows HA, HB, and HC shown in FIG. 2 by the conveyance mechanism 32. The laser light L is emitted from a back side of the base plate 1 of sapphire, and a boundary face between the base plate 1 and the material layer 2 is irradiated therewith. The shape of the laser light L is approximately formed in a shape of a rectangle. As shown in FIGS. 1 and 2, a first conveyance operation HA, in which the workpiece 3 is conveyed in the direction of the arrow A of FIG. 1 according to the size of the workpiece itself; a second conveyance operation HB, in which the workpiece 3 is conveyed in a direction perpendicular to a conveyance direction of the first conveyance operation HA (a direction of the arrow C of FIG. 1), by only a distance, which is obtained by deducting, from a distance equivalent to an irradiation region S of one shot of laser light, an overlapped region ST where irradiation regions are overlapped; and a third conveyance operation HC, in which it is conveyed in a direction of the arrow B of FIG. 1, are performed one by one. The conveyance direction of the first conveyance operation HA is different from that of the third conveyance operation HC by 180 degree. Here, the optical system of the laser light is fixed and not conveyed. That is, when only the workpiece 3 is conveyed while the optical system of laser light is fixed, as shown in the arrow of FIG. 2, the irradiation region of the laser light L of the workpiece 3 relatively changes every moment such as S1, . . . S10, . . . in order.

Next, a concrete description of a laser lift-off processing according to an embodiment of the present invention will be given below. Although the workpiece 3 has a circular contour in the embodiment shown in FIG. 2, the irradiation region of the laser light becomes approximately rectangular, so that a laser irradiation method for an irradiation region having such a rectangle shape is will be explained. As shown in FIG. 2, the workpiece 3 is conveyed in the direction HA of FIG. 2, and while end portions (edge parts) of irradiation regions are overlapped with respect to four irradiation regions S1, S2, S3 and S4, each is irradiated with laser light 4 once, that is, four times in total. This is the first conveyance operation. Next, the workpiece 3 is conveyed in the direction HB of FIG. 2, so that the next irradiation region S5 of the workpiece 3 may be irradiated with the laser light. This is the second conveyance operation. A distance, by which the workpiece 3 is conveyed in a direction of the arrow HB, is equal to a distance, which is obtained by deducting the overlapped region ST from a distance corresponding to the irradiation region of one shot (one pulse) of the pulsed laser light. Next, while the workpiece 3 is conveyed in the direction HC of FIG. 2, each of six irradiation regions S5, S6, S7, S8, S9 and S10 is irradiates with laser light once, that is, six times in total. This is the third conveyance operation. By conveying the workpiece 3 with respect to the other irradiation regions of the workpiece 3, following a series of the steps, the entire area of the workpiece 3 is irradiated with laser light.

Although the irradiation region of laser light will move relatively in the order of S1, S2, and S3 as shown in FIG. 2, each irradiation region is, for example, 0.5 mm*0.5 mm, and the area thereof is set to 0.25 mm². On the other hand, the area of the workpiece 3 is 4560 mm². That is, the irradiation regions S1, S2 and S3 of laser light are far smaller than the area of the workpiece. In the laser lift-off treatment according to the present embodiment, while the workpiece 3 is scanned with the laser light with an irradiation region smaller than the workpiece 3, in the directions of the arrows A and B shown in FIG. 1 (that is, horizontal directions of the workpiece), the workpiece 3 is irradiated therewith. In addition, contrary to this embodiment of the present invention, a laser optical system may be conveyed according to the above-mentioned conveyance operation HA or HC, while the workpiece is fixed. What is necessary is just to irradiate the workpiece with laser light so that the irradiation region of the laser light on the workpiece may change every moment with time.

As shown in FIG. 2(b), respective end portions in a width direction of the regions S1, S2, and S3 of the workpiece 3, which adjoin each other in the conveyance direction HA of the workpiece 3, and which are irradiated with the pulsed laser light, are overlapped each other. Moreover, respective end portions in a width direction of the regions S1 and S9, S2 and S8, S3 and S7, and S4 and S6 of the workpiece 3, which adjoin each other in a direction perpendicular to the conveyance direction HA of the workpiece 3, and which are irradiated with the pulsed laser light are, overlapped each other. The width of the overlapped region ST of the workpiece 3 is, for example, 0.1 mm. The pulse interval of the laser light is suitably set by taking into consideration, the conveyance speed of the workpiece, and the width of the overlapped regions ST of the adjoining irradiation regions S1, S2, and S3 . . . on the workpiece 3 which are irradiated with the laser light. Basically, the pulse interval of the laser light is determined so that the workpiece may not be irradiated with the laser light before the workpiece is moved to the next irradiation region. That is, for example, the pulse interval of laser light is set up so as to be shorter than time required in order that the workpiece may be moved by a distance corresponding to the irradiation region for one shot of laser light. For example, when the conveyance speed of the workpiece 3 is 100 mm per second and the width of the overlapped region ST of the laser light is 0.1 mm, a pulse interval of the laser light is 0.004 second (250 Hz).

FIG. 3 is a conceptional diagram showing the structure of an optical system of a laser lift-off apparatus according to an embodiment of the present invention. As shown in the figure, the laser lift-off apparatus 10 comprises a laser source 20 which generates pulsed laser light, a laser optical system 40 which generates laser light in a predetermined shape, the workpiece stage 31 on which the workpiece 3 is placed, the conveyance mechanism 32 which conveys the workpiece stage 31, and a control unit 33 for controlling an irradiation interval of the laser light, which is generated by the laser source 20, and an operation of the conveyance mechanism 32. The laser optical system 40 comprises cylindrical lenses 41 and 42, a mirror 43, which reflects the laser light toward the workpiece, a mask 44 for forming the laser light in a predetermined shape, a projection lens 45 for projecting an image of laser light L, which has passed through the mask 44, on the workpiece 3. The area and shape of the irradiation region of the pulsed laser light on the workpiece 3 can be suitably set up by the laser optical system 40. The workpiece 3 is arranged downstream of the laser optical system 40. The workpiece 3 is placed on the workpiece stage 31. The workpiece stage 31 is placed on the conveyance mechanism 32, and is conveyed by the conveyance mechanism 32. This makes the workpiece 3 move in order in the directions of the arrows A and B shown in FIG. 1, and the laser light irradiation region on the workpiece 3 changes every moment. The control unit 33 controls the pulse interval of the pulsed laser light generated in the laser source 20, so that an overlapped degree of each laser light with which the adjoining irradiation regions of the workpiece 3 is irradiated, may become a desired value.

The laser light L which is generated by the laser source 20 is, for example, a KrF excimer laser, which generates ultraviolet rays with a wavelength of 248 nm. An ArF laser or YAG laser may be used as such a laser source. Here, an optical incidence plane 3A of the workpiece 3 is arranged on a side distant from a focal point F of the projection lens 45 in an optical axis direction of the laser light. On the contrary, the optical incidence plane 3A of the workpiece 3 may be arranged so as to be brought close to the projection lens 45 from the focal point F of the projection lens 45 in the direction of the optical axis of laser light. In such a way, light intensity distribution of the laser light whose cross section is in a shape of a trapezoid, can be obtained, as shown in FIG. 4, by arranging the optical incidence plane 3A of the workpiece 3 so as not to be in agreement with the focal point F of the projection lens 45. After the pulsed laser light L generated by the laser source 20 passes through the cylindrical lenses 41 and 42, the mirror 43, and the mask 44, it is projected on the workpiece 3 by the projection lens 45. As shown in FIG. 1, the pulsed laser light L is illuminated through the base plate 1 on the boundary face between the base plate 1 and the material layer 2. GaN near the boundary face region of the material layer 2 and the base plate 1 is broken down by illuminating the pulsed laser light L on the boundary face between the base plate 1 and the material layer 2. Thus, the material layer 2 is separated from the base plate 1.

The GaN of the material layer 2 is broken down into Ga and N₂ by irradiating on the material layer 2 with the pulsed laser light. When the GaN is broken down, a phenomenon, which is like an explosion, arises, and an edge part of the irradiation region of the pulsed laser light on the material layer 2 is damaged more than a little. In the laser lift-off treatment according to the present invention, as described below, the area and the boundary length of an irradiation region of the pulsed laser light, with which the material layer 2 are irradiated, are set to a predetermined relation, whereby when the GaN is broken down, a damage applied to an edge part of a region, which is irradiated with pulsed laser light, is reduced, and generation of cracks in the material layer 2 is prevented.

FIG. 4 is a diagram showing light intensity distribution of laser light with which adjoining regions S1 and S2 of the workpiece 3 shown in FIG. 2 are irradiated so as to be overlapped each other and is a cross sectional view thereof taken along a line a-a′ of FIG. 2(b). In the figure, a vertical axis shows the intensity (energy value) of laser light, with which each irradiation region of the workpiece is irradiated, and a horizontal axis shows a conveyance direction of the workpiece. Moreover, L1 and L2 show profiles of laser light, with which irradiation regions S1 and S2 of the workpiece are irradiated, respectively. In addition, the laser lights L1 and L2 are not necessarily emitted simultaneously, and the laser light L2 is emitted in one pulse interval after the laser light L1 is emitted. In this example, as shown in FIG. 4, a cross section of the laser lights L1 and L2 is formed in an approximately trapezoid shape, which has a flat face on a top part (peak energy PE), following an edge part LE which gently spreads in a circumferential direction. And, as shown by a dashed line in FIG. 4, the laser lights L1 and L2 are overlapped in a region of energy, which exceeds a breakdown threshold VE required for breaking down the material layer of a GaN compound thereby separating it from the sapphire base plate.

That is, at an intersection C of the laser lights L1 and L2 in the light intensity distribution of each laser light, the intensity of laser light (energy value) CE is set up so as to become a value, which exceeds the above-mentioned breakdown threshold VE. This is because, as described above, when the irradiation region is moved from S1 to S2 after irradiating the irradiation region S1 of FIG. 2 with laser light, since the temperature of the region S1 has been already decreased to a room temperature level, so that even if the irradiation region S2 is irradiated with the laser light in the state where the temperature of the irradiation region S1 decreases to the room temperature level, the irradiance of the pulsed laser light, with which each irradiation region S1 and S2 is irradiated, is not integrated. When the intensity CE of the laser light at the intersection C of the laser lights L1 and L2, that is, the intensity of each pulsed laser light on a region where the laser lights are superimposed and irradiated, is set up so as to become a value exceeding the above-mentioned breakdown threshold VE, it is possible to apply laser energy to the material layer sufficient to separate the material layer from the base plate, so that the material layer can be certainly separated from the base plate, without causing cracks of the material layer formed on the base plate.

On the other hand, if the intensity of each pulsed laser light on a region ST where edge parts of the above-mentioned irradiation regions S1 and S2 are overlapped, is too large with respect to the breakdown threshold, which is required for separating the above-mentioned material layer from the above-mentioned base plate, it was confirmed that a problem that the material layer was re-bonded to the base plate, arises. It is thought that, when the same region is irradiated with high intensity pulsed laser light twice, the material layer, which is separated from the base plate once, is bonded thereto again by the second irradiation of the pulsed laser light. It turned out from experiments etc. that the intensity of the laser light on the region where each laser light is superimposed, is desirable to be set to VE*1.15 or less in relation to the breakdown threshold VE required for making the above-mentioned material layer separate from the above-mentioned base plate. That is, when the [the intensity of laser light on a region where laser light is superimposed (maximum value)]/[breakdown threshold VE] is defined as a superimposition degree T, it is desirable to set the superposition degree T to 1≦T≦1.15. in order to make the material layer certainly separate from the base plate without causing cracks in the material layer formed on the base plate, and without rebonding to the base plate. In addition, a pulse interval of the laser light is in advance adjusted with respect to the relative movement amount of the workpiece 3 and laser light, so that the laser light, with which the adjoining irradiation regions of the workpiece 3 are irradiated, may be overlapped as described above. In the embodiment shown in the figure, since the material layer is made of GaN, the breakdown threshold is 500-1500 J/cm². It is necessary to set up the breakdown threshold VE depending on substance which forms the material layer.

In order to confirm the above, a comparative example of FIG. 5(a) is shown in which when the workpiece was irradiated with laser lights L1 and L2 whose laser light intensity distributions intersect with each other at an energy region where they were less than the breakdown threshold VE, an undegraded region of GaN, which formed the material layer, was formed so that the material layer could not be fully separated from the base plate. The undegraded region of GaN was in agreement with the overlapped region ST where the laser lights L1 and L2 were superimposed on the workpiece. On the other hand, when the workpiece was irradiated with the laser light shown in the comparative example of FIG. 5(b), since a superposition degree T of the laser lights L1 and L2 was too large, a lot of dirt like black spots was formed on a surface thereof, as shown in FIG. 6(b-4) showing an experimental result, as to a surface condition of the material layer after the separation, which is described below. This is, it is thought that when the same portion was twice irradiated with the laser light having large energy, the material layer, which was separated from the base plate once, was rebonded thereto by the second irradiation of the laser light, and the component of sapphire, which formed the base plate, adhered thereto. Thus, the black spots formed on the surface of the material layer had a bad effect on luminescent property.

In order to confirm the above, a workpiece, in which a GaN material layer was formed on a sapphire base plate, was irradiated with laser lights L1 and L2, which had the light intensity distribution in a shape of a rectangle shown in FIG. 6(a) (pulsed laser light which a KrF laser outputs), whereby the surface of the material layer after separation was examined. In the experiment, the intensity of the laser lights at a region where the laser lights L1 and L2 are overlapped, was changed for irradiation, to 105%, 110%, 115%, and 120% with respect to the breakdown threshold VE (870 mJ/cm²) of the GaN material layer, whereby the surface of the material layer after separation was examined. FIGS. 6(b-1), (b-2), (b-3) and (b-4) show a surface of the material layer after separation in case where the intensity of the laser light on a region to be superimposed was changed to 105%, 110%, 115%, and 120%, respectively, with respect to the breakdown threshold VE. As shown in FIGS. 6(b-1), (b-2) and (b-3), when the intensity of the laser light on the superimposed region was 105%, 110% and 115% with respect to the breakdown threshold VE, the surface condition of the material layer after separation was good, and no bad influence on luminescent property such as dirt and scratches, was found. On the other hand, when the intensity of laser light was set to 120% with respect to the breakdown threshold VE, as shown in FIG. 6(b-4), a lot of dirt like black spots was formed as to the surface condition of the material layer after separation. In view of the above, it is thought that, by setting the laser energy in a range of VE*1 to VE*1.15 with respect to the breakdown threshold VE of GaN, a laser lift-off treatment could be performed without damaging the surface of GaN material layer including the region where the laser light is superimposed, which is irradiated with laser light.

As described above, although it is necessary to appropriately select the intensity of laser light in order to prevent damages to the material layer at time of a laser lift-off, it was confirmed, as a result of further study, that the irradiation area of the laser light at the time of the laser lift-off greatly affects the damage to the material layer. As described above, GaN of the material layer 2 is broken down into Ga and N₂ when the material layer 2 is irradiated with the pulsed laser light. When GaN is broken down, although a phenomenon, which is like an explosion, arises, and an edge part of the irradiation region of the pulsed laser light in the material layer 2 is damaged, the size of the damages due to the breakdown is deemed to greatly depend on the irradiated area of the laser light. That is, it is considered that, for example, the amount of produced N₂ gas etc. is larger as the irradiation area S is larger, so that a larger force is applied to the edge part of the irradiation region of the pulsed laser light. On the other hand, when the length L of the edge part (the boundary length of the irradiation region) becomes larger, even if the force to be added to the above-mentioned edge part becomes large, the force to be added per unit length becomes small, so that damages thereto become small even if the irradiation area is the same.

Table 1 shows the shape (x, y) of the irradiation region in the laser lift-off treatment, the area (S) thereof, the side length (L) thereof, S/L, a stress applied to each side thereof and an evaluation result thereof in the experiment. Here, the shape of the irradiation region was rectangular, and in Table 1, x (mm) and y (mm) were horizontal and vertical lengths of the irradiation region respectively, S (mm²) was the area (x*y) of the irradiation region, L (mm) was the boundary length of the irradiation region (2x+2y), and S/L was a ratio of the area S and the length L of the sides. Moreover, as to the stress (Pa), when the pressure of N₂ generated by breakdown of GaN was calculated, it was 6000 atmospheres (since volume increased 6000 times, the pressure became 6000 times the atmospheric pressure), wherein the simulation of a distortion stress to GaN due to the pressure was carried out, and the maximum value of the distortion stress distribution is calculated. Moreover, the evaluation result in the experiment was obtained by examining the surface condition of the material layer when a laser lift-off treatment was actually performed on the conditions shown in the table. In this experiment, a KrF laser, which emitted laser light with a wavelength of 248 nm was used and laser irradiation energy to a workpiece was set to VE*1.1 with respect to the breakdown threshold VE of the GaN material layer. In addition, the breakdown threshold of the GaN material layer was 870 J/cm². In addition, it is thought that even when laser energy is changed in a range of VE*1 to VE*1.15 with respect to the breakdown threshold VE of GaN, the same result as the result shown in the above-mentioned table 1 can be obtained.

In Table 1, a symbol 0 shows case where the surface condition of the material layer was good (there was no damage) after a laser lift-off treatment was performed, and a symbol x shows case where dirt was formed (there are damages). FIG. 7 is a schematic diagram showing this experimental result, in which (a)-(e) thereof respectively show the experimental result of Nos. 1, 4, 6, 7, and 9 of Table 1. It is noted that the above-mentioned experiments on Nos. 2, 3, and 5 of Table 1 were not conducted.

TABLE 1

| | | | | Length L | | | Evaluation |
|---|---|---|---|---|---|---|---|
| | No. x | | Area S | of sides | | Stress | in the |
| No. | [mm] | y [mm] | [mm] | [mm] | S/L | [Pa] | experiment |
| 1 | 0.1 | 1.0 | 0.1 | 2.2 | 0.045 | 7.48*10⁸ | ◯ |
| 2 | 0.1 | 2.5 | 0.25 | 5.2 | 0.048 | 7.97*10⁸ | Unad- |
| | | | | | | | ministered |
| 3 | 0.1 | 7.0 | 0.7 | 14.2 | 0.049 | 8.36*10⁸ | Unad- |
| | | | | | | | ministered |
| 4 | 0.3 | 0.3 | 0.09 | 1.2 | 0.075 | 9.44*10⁸ | ◯ |
| 5 | 0.2 | 1.0 | 0.2 | 2.4 | 0.083 | 1.04*10⁸ | Unad- |
| | | | | | | | ministered |
| 6 | 0.3 | 1.0 | 0.3 | 2.6 | 0.115 | 1.44*10⁹ | ◯ |
| 7 | 0.5 | 0.5 | 0.25 | 2.0 | 0.125 | 1.53*10⁹ | ◯ |
| 8 | 0.6 | 0.6 | 0.36 | 2.4 | 0.150 | 2.02*10⁹ | X |
| 9 | 1.0 | 1.0 | 1.0 | 4.0 | 0.250 | 4.34*10⁹ | X |
| 10 | 1.2 | 1.2 | 1.44 | 4.8 | 0.300 | 7.97*10⁹ | X |

It is apparent from in Table 1 that the S/L value and the stress value of No. 7 among Nos. 1, 4, 6, and 7, in which no damage was confirmed, were largest. Moreover, in the experiment of No. 8, a stress value was 2.02*10⁹ Pa and it was confirmed that there was damage. In general, the S/L value and the stress value bear an approximately proportionate relation to each other. From the above result, it is thought that when the S/L was 0.125 or less, a stress value became 1.53*10⁹ Pa or less, so that there was no damage. On the other hand, it is thought that when the S/L exceeded the above-mentioned value, the material layer after separation was damaged. That is, it is thought that a laser lift-off treatment could be performed without causing damage by setting the value of [the area S]/[the boundary length L of an irradiation region] to 0.125 or less.

In addition, it is thought that as shown in Table 1, when the irradiation region of laser light was a square, a laser lift-off treatment could be performed without causing any damage by setting the area of the irradiation region to 0.25 mm² or less. However, when the irradiation region was rectangular so that the length of one side x and that of another side y were different from each other, since a value of [irradiation area S]/[the boundary length L of the irradiation region] became small even when the area was the same, the upper limit of the area of the irradiation region became larger than the above-mentioned value. As shown in Table 1, the area of the irradiation region was 0.7 mm², when x of the irradiation region of No. 3 is 0.1 mm and y thereof is 7.0 mm (aspect ratio 70), and the stress value in this case was 8.36*10⁸ Pa, and although the area of the irradiation region was larger than that in the above No. 7 (the area thereof is 0.25 mm²), it became smaller than the stress value of No. 7, which was 1.53 *10⁹ Pa. That is, it is thought that although the area of an irradiation region has big influence on generation of a damage, a force applied to an edge part of the irradiation region is made small by setting up so that [the irradiation area S]/[the boundary length L of the irradiation region] may become 0.125 or less, whereby the damage to the material layer can be made small.

However, since the shape of the irradiation region has restrictions in view of the structure of the laser apparatus and the optical element etc., so that the laser apparatus becomes large and the cost thereof goes up, it is difficult to form an extremely long and thin irradiation region. Furthermore, although irradiation distribution of a laser beam is desirably set to a range within ±5%, since it is difficult to satisfy such a demand by an extremely long and thin beam, it is actually necessary to set the aspect ratio of the irradiation region to 70 or less. In addition, since as to the shape of the above-mentioned irradiation region, it is necessary to overlap edge parts of the irradiation regions which adjoin each other as described above, it is desirably rectangular, and as shown in FIG. 2, when each region (S1, S2, S3 . . . ) of the pulsed laser light, with which the workpiece 3 is irradiated, is formed in a shape of approximately a square, as described above, the area of the irradiation region needs to be 0.25 mm² or less, and desirably 0.1 mm² or less ideally. Moreover, it is ideal that one side is preferably 0.3 mm or less, when the shape of an irradiation region is a square. In addition, the beam shape (the shape of an irradiation region) may not be limited to a rectangle or a square, it may be, for example, a parallelogram.

Next, a description of a method for manufacturing a semiconductor light emitting element capable of using the above-mentioned laser lift-off method, will be given. Hereinafter, the method for manufacturing a semiconductor light emitting element, which is formed of a GaN compound material layer, is explained referring to FIG. 8. A sapphire base plate capable of crystal growth of gallium nitride (GaN) series compound semiconductor, which transmits laser light and forms a material layer, is used as the base plate for crystal growth. As shown in FIG. 8(a), a GaN layer 102, which consists of a GaN series compound semiconductor, is quickly formed on a sapphire base plate 101 by, for example, using a metal-organic chemical vapor deposition (the MOCVD method). Then, as shown in FIG. 8(b), an n-type semiconductor layer 103 and a p-type semiconductor layer 104, which are light emitting layers, are laminated on a surface of the GaN layer 102. For example, GaN, in which silicon is doped, is used as the n-type semiconductor, and GaN, in which magnesium is doped, is used as the p-type semiconductor. Then, as shown in FIG. 8(c), a solder 105 is applied on the p-type semiconductor layer 104. Then, as shown in FIG. 8(d), a support base plate 106 is attached to the solder 105. The support base plate 106 is made of an alloy of copper and tungsten. And, as shown in FIG. 8(e), the laser light 107 is emitted towards a boundary face between the sapphire base plate 101 and the GaN layer 102 from a back side of the sapphire base plate 101. By the laser light 107, an irradiation region is in a shape of a square whose area is 0.25 mm² or less, and the light intensity distribution is in a shape of an approximately trapezoid, as shown in FIG. 4. The boundary face between the sapphire base plate 101 and the GaN layer 102 is irradiated with the laser light 107, whereby the GaN layer 102 is separated from the sapphire base plate 101 by breaking down the GaN layer 102. An ITO108, which is a transparent electrode, is formed on a surface of the GaN layer 102 after the separation by vapor deposition, and an electrode 109 is attached to the surface of ITO108.

### REFERENCE SIGNS LIST

1 Base plate

2 Material Layer

3 Workpiece

10 Laser Lift-off Apparatus

20 Laser Source

31 Workpiece Stage

32 Conveyance Mechanism

33 Control Unit

40 Laser Optical System

41, 42 Cylindrical lenses

43 Mirror

44 Mask

45 Projection Lens

101 Sapphire Base Plate

102 GaN Layer

103 N-type Semiconductor Layer

104 P-type Semiconductor Layer

105 Solder

106 Support Base Plate

107 Laser Light

108 Transparent Electrode (ITO)

109 Electrode

L Laser light

1. A laser lift-off method wherein a work piece, in which a crystalline layer is formed on a base plate, is irradiated with pulsed laser light through the base plate, so that edge portions of irradiation regions, which adjoin each other in an irradiation moving direction, are overlapped each other, and edge portions of irradiation regions, which adjoin each other in a direction perpendicular to the irradiation moving direction, are overlapped each other, whereby the crystalline layer is separated from the base plate on a boundary face between the base plate and the crystalline layer, while changing a region of the workpiece to be irradiated with the pulsed laser light, and
wherein the overlapped end portions of irradiation regions, are irradiated with pulsed laser light whose energy which exceeds a breakdown threshold required for separating crystalline layer from the base plate,
wherein each of the irradiation regions of the workpiece, which is irradiated with the pulsed laser light, is quadrangular, and an aspect ratio thereof is 70 or less, and
wherein each of the irradiation regions of the workpiece, which is irradiated with the pulsed laser light, satisfies a relation of S/L≦0.125 when the area of this region on the workpiece irradiated with the pulsed laser light is represented as S (mm²) and a boundary length of the irradiation region is represented as L (mm)

2. (canceled)

3. A laser lift-off apparatus, in which a work piece, where a crystalline layer is formed on a base plate, is irradiated with pulsed laser light through the base plate, so that edge portions of irradiation regions, which adjoin each other in an irradiation moving direction, are overlapped each other, and edge portions of irradiation regions, which adjoin each other in a direction perpendicular to the irradiation moving direction, are overlapped each other, whereby the crystalline layer is separated from the base plate on the boundary face between the base plate and the crystalline layer while changing the region on the workpiece irradiated with the pulsed laser light, comprising:
a laser source, which generates pulsed laser light of a wavelength band, passing through the base plate and required for breakdown of the crystalline layer, wherein the overlapped end portions of irradiation regions, are irradiated with pulsed laser light whose energy which exceeds a breakdown threshold required for separating crystalline layer from the base plate;
a conveyance mechanism, which conveys the workpiece; and
a laser optical system, which forms the pulsed laser light emitted from the laser source, wherein each of the irradiation regions of the workpiece, which is irradiated with the pulsed laser light, is quadrangular, and an aspect ratio thereof is 70 or less, and wherein a relation of S/L≦0.125 is satisfied, when the area of the region on the workpiece irradiated with the pulsed laser light is represented as S (mm²) and the boundary length of the irradiation region is represented as L (mm).

4. (canceled)
